(19) United States
(12) Patent Application Publication
(10) Pub. No.: US 2011/0079971 A1
(43) Pub. Date: Apr. 7, 2011

(54) Buoyant Animal Cage

(76) Inventor: Ed B. Lulevitch, Ridley Park, PA (US)

(21) Appl. No.: 12/992,629

(22) PCT Filed: May 5, 2008
(86) PCT No.: PCT/US08/62625

§ 371 Date: Nov. 15, 2010

(51) Int. Cl. A01K 1/03; A01K 29/00; B63B 38/00; B62B 13/00

(52) U.S. Cl. 280/28.12; 119/496; 441/136

(57) ABSTRACT

A floating cage system for containing and transporting animals over water is described. This is useful in flood conditions or when hunting to keep animals and pets out of the water. The cage system has a buoyant base equipped with towing and lifting hooks and handles for easy pulling. The cage system has a top that forms a watertight seal with the base. The top has a door that opens from the top, allowing easier access to the cage than a door that opens from the side.

### BACKGROUND OF THE INVENTION

The present invention relates to a buoyant animal rescue and containment shelter for domestic and wild animals. The disclosed invention provides assistance to a rescuer transporting an animal from the point of rescue to a waiting vessel or location of safety by reducing the physical load for the rescue worker while providing safety and floatation for the animal in a flooded environment. Used as an animal containment, the present invention provides a resting place for an animal, such as a hunting dog, that allows the animal to conserve energy while not working. Additionally, the present invention provides a floating support for equipment and supplies used by a rescue worker or hunter engaged in activities in the water.

During natural disasters, people frequently need to flee an area leaving animals behind. Emergency shelters and other rescue agencies frequently do not allow animals to accompany their owners that they are evacuating from an area. This is normally because of safety issues and limitations on food, water, and the ability to maintain a sanitary environment.

Natural disasters frequently include flooding, such as when a hurricane strikes or other flooding occurs from heavy rains or snow melt in flood prone areas. Residents fleeing such areas frequently leave their cats, dogs, and other domestic pets behind, most often, by necessity. At the first possible moment, it is understandable that residents want to rescue their pets before flood waters or other hazardous conditions have an opportunity to recede. When resources and manpower allow, and when human victims have first been rescued, rescuers can return to attempt to rescue those domestic animals left behind and unable to flee because of flooding.

In the past, rescue workers have observed that it is burdensome to place an animal within a conventional carry cage and then to swim or wade through flood waters from the point of rescue to a waiting boat, helicopter, or other vehicle or relatively safe location. The rescued animal must be placed in a cage for its own safety and the safety of the rescue worker. When carrying the cage containing the rescued animal, the cage must be held high above the water level, inducing fatigue of the rescue workers. A floatation system is necessary to allow the rescued animal to safely be transported to a separate location without putting undue physical stress upon a rescue worker that otherwise would have to hold the animal above the water level.

Conventional pet cages, and even those that may float do not provide a satisfactory solution because such cages are heavy and complex. There is a need for an improvement in an animal rescue portable cage system which reduces the work load on the rescue worker by allowing the rescue worker to transport the animal while the buoyancy of the cage supports the weight of the animal.

A floating cage system may also be used in the capture and transport of wild animals through aquatic environments. This system would allow people to capture animals that would otherwise be difficult to capture and transport, such as birds, aquatic mammals or reptiles. Such a floating cage would be particularly useful in the capture and treatment of animals that have been contaminated in events such as oil spills.

A floating cage system would also be useful in the sport of hunting. Often, a hunting dog has to wait, sitting or standing in water for long periods. A floating cage system allows the hunting dog to wait in the cage, out of the water, until the dog is needed. Additionally, hunters must cross bodies of water with their dogs. A floating cage system allows the hunter to safely transport both the dog and other equipment with minimal effort, such as by pushing or pulling the floating cage.

### SUMMARY OF THE INVENTION

The present invention is a cage system for animals that has a floatation device attached or integrated. The cage system is designed to have high buoyancy, light weight, and to be stable so as not to easily capsize in rough waters or as a result of sudden weight shifts due to animal movement or equipment loading or removal. The cage system is also designed to minimize the intake of water from splashing and rain.

In the preferred embodiment, the cage system is comprised of a top and a base. The base provides floatation and a relatively rigid surface to support the animal, while the top defines a cage interior when mated to the base. The top and base fit together, forming a seal. In the preferred embodiment, a gasket is used between the top and the base to help form the seal. In the preferred embodiment, the top and base are secured together by fasteners, such as a plastic rivet, or by removable fasteners such as latches.

A door is attached to the top. In the preferred embodiment, the door is attached to the roof and is a double hinged door. There are two sections of the door, defined by the two hinges. Between the hinge connecting the door to the roof and the second hinge is a first door section. This first door section closes in the plane of the roof and forms a seal with the roof. A second door section goes from the second hinge to the end of the door, and this second section closes on the front of the top. When the door is in the open position, the door rests on the roof of the top. The preferred embodiment has two latches that can lock the door in the closed position.

The preferred embodiment has attached to the base handles to let a user pull or push the cage system through water. Also attached to the base are tow hooks that can be attached to a tow line. This lets a user or a boat tow the cage system along behind. Also attached to the base are ring hooks to allow the cage system to be lifted with an animal inside. The ring hooks can also be used for a tie down.

The preferred embodiment has a handle attached to the top. A light beacon may optionally be attached to the handle, letting a user easily see the cage system. A flashlight may optionally be attached to the handle. The flashlight is particularly useful when the person carrying the cage needs a free hand or is carrying something else in his other hand. Highly reflective material may be optionally part of the top so that the cage may be easily located in the beam of a flashlight or searchlight. An identification plate, radar reflector, radio beacon, or global positioning system device may be attached to either the top or base to facilitate identification and location, as well.

One embodiment of the invention has outriggers deployably attached to the base. The outriggers may be in an open or closed position. When closed, the outriggers are adjacent to, or integrated with the base. When open, the outriggers give additional stability to the cage system when floating so that it is more difficult to capsize. The outriggers may also provide additional buoyancy when deployed.

Another embodiment of the invention has three major components, a top, a bottom, and a buoyancy device. The top and bottom form a single, relatively watertight unit, which is then placed upon and attached to the buoyancy device. This embodiment has the advantage that the single unit can be used as a cage in normal circumstances, but when needed, may be easily converted to a floating cage system.

### BRIEF DESCRIPTION OF THE DRAWINGS

FIG. 1 is a pictorial view of the cage system with the door open.

FIG. 2 is a pictorial view of the cage system with the door closed.

FIG. 3 is perspective exploded view of the cage system.

FIG. 4 is a side view of the cage system.

FIGS. 5a and 5b are views of the handle in the open and folded positions.

FIG. 6 is a side view showing the cage system interacting with lifting ropes and a tow line.

FIG. 7 is a pictorial view of the cage system with outriggers in the closed position and the door open.

FIG. 8 is a pictorial view of the cage system with outriggers in the closed position and the door closed.

FIG. 9 is a perspective exploded view of the cage system with outriggers in the closed position.

FIG. 10 is a side cutaway view showing the catch for the outriggers.

FIG. 11 is a bottom plan view showing the catches for the outriggers.

FIG. 12 is a bottom plan view showing the outriggers in the open position.

FIG. 13 is a perspective view showing the outriggers in the open position.

FIG. 14 is an exploded perspective view showing the latches for retaining the cage in the buoyant member.

### DETAILED DESCRIPTION OF THE INVENTION

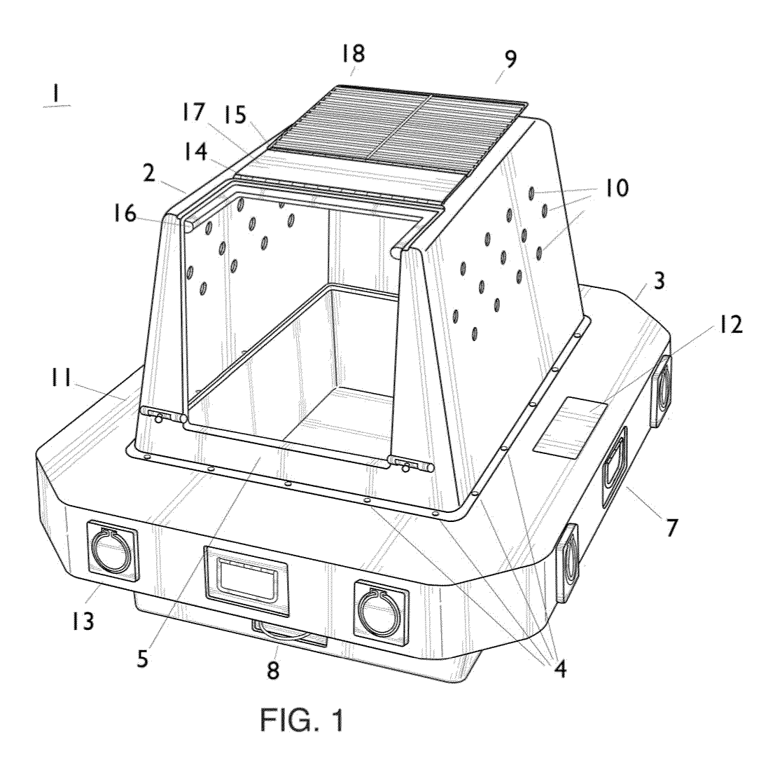

With reference to FIG. 1, the preferred embodiment of the invention is a cage system 1 with a top 2 and a base 3. The top 2 is fastened to the base 3 by one or more (optionally removable) fasteners 4. Where the base 3 and top 2 meet, the base 3 has a lip 5 that retards the entry of water into the interior of the cage system.

The base 3 is constructed from a buoyant material, and the preferred embodiment uses a foam filled structure, however other buoyant materials are envisioned, including but not limited to wood, plastic, metal, composite materials, and rubber tubing. In the preferred embodiment, the base 3 is a rectangular structure with a hollow depression or indentation in the middle for an animal to be placed. The base 3 has a floor for the animal to be placed upon.

In the preferred embodiment, the cage system has a removable grate 6 (not shown) to be placed over the floor and to be supported at a predetermined vertical distance from the floor. The removable grate 6 allows for an animal to be out of any water that might have spilled into the cage system. The removable grate 6 also allows the animal to be out of any waste produced by the animal while waiting in the cage system.

In the preferred embodiment of the invention, there are handles 7 attached to the base 3 to allow for lifting. The preferred embodiment has four handles, one on each side of the base 3. However, it is envisioned that the invention may have no handles, or any number of handles, or handles on just one or two sides.

In the preferred embodiment, there is a hook 8 on one side, preferably the front of the base 3 for towing the cage system. Preferably, the hook 8 is located low on the base 3 to give more stability while towing. However, it is also envisioned that the hook may be placed elsewhere on the cage of the present invention, or that the hook may be omitted from the invention. It is also envisioned that more than one hook may be present. In another embodiment of the invention there is a second hook attached to the back of the base 3. This allows for more than one cage system to be linked together, making towing more than one cage system easier. In other embodiments, there is a hood attached to each side of the base.

The preferred embodiment of the cage system has a number of ring hooks 13 attached to the front, back and/or sides of the base. The ring hooks 13 are multifunctional and can be used for lifting the cage system or tying down the cage system. The ring hooks 13 can also be used to attach a tarp or other material over the cage system. The preferred embodiment envisions two ring hooks on each side of the base. Other embodiments of the cage system might use more ring hooks or eliminate the ring hooks.

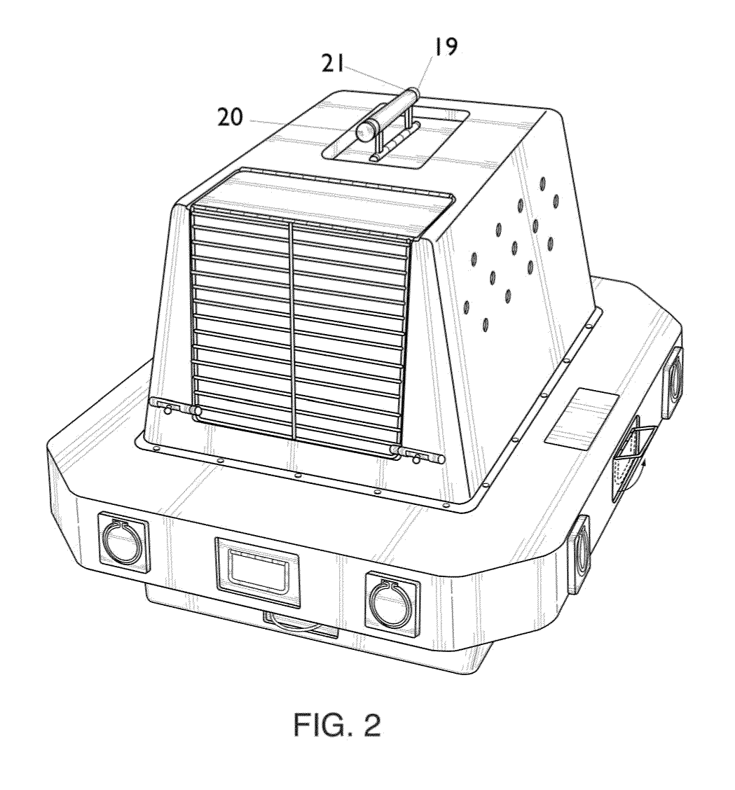

The top 2 has a back, two side walls and a roof. A door 9 is attached to the top 2 to close the cage system. In the preferred embodiment, the door 9 is attached to the roof of the top and has two hinges. Between the first hinge 14 of the door and the second hinge 15 is a first section 17 of the door of the door which closes along the plane of the roof. Between the second hinge 15 and the end of the door is a second section 18. The second hinge 15 of the door, when closed, lies along an edge of the top 2, allows a second section 18 of the door to close against the front of the top. The two hinge door allows for easier access for animals to get in and out of the cage system. The door can either be in an open position, FIG. 1, or in a closed position, FIG. 2. In the preferred embodiment, the first section 17 of the door that closes against the roof of the top is solid and makes a relatively water tight seal against the roof. In the preferred embodiment, this is accomplished by having a lip 16 around the opening in the roof where the door closes.

The top 2 optionally has a number of holes 10 for ventilation and light which make the interior of the cage system more inviting and comfortable for an animal. In the preferred embodiment, the holes 10 are placed along the side walls of the top 2. Other embodiments may eliminate the holes to prevent water from entering the interior of the cage system. Other embodiments may have a transparent or translucent plate that slides into place over the holes to prevent water from entering the interior of the cage system. This plate may be a synthetic plastic material.

The preferred embodiment has two latches 11 on either side of the door on the front that secure the door in the closed position. The preferred embodiment uses slide latches, however it is envisioned that other types of latches may be used to secure the door in the closed position including hook and loop fasteners, magnetic closures, throw-over-center latches, hook and eye hasps, and the like.

The invention has an identification plate 12 on the cage system to allow for easy identification of the cage system and the animal in the cage system. The preferred embodiment of the cage system has the identification plate 12 on the base, however other embodiments may place the identification plate on the top of the cage system. In other embodiments, the identification plate may be in addition to or replaced with a GPS tracking device, radio transmitter beacon, radar reflector, and/or reflective material such as tape, in any desired combination. In addition, a number of attachment points (not shown) may be provided for attachment of auxiliary equipment to the top 2. For example, common attachment points may allow attachment of a weapon, of hunting tools, two-way radio equipment, food and water containers, and the like to the exterior of top 2. These attachments would allow interchangeable accessories to be attached to the cage system. These accessories include but are not limited to a cup holder, a gun holder, and a watertight box for gun shells. In one embodiment, these accessories are fastened to the attachments by slotted T holders.

With reference to FIG. 2, a handle 19 for carrying is on the roof of the top 2. In the preferred embodiment, the handle 19 can fold down and lies in a recess that allows for the handle to retract into the plane of the top 2. In the preferred embodiment, a water resistant light beacon 20 is attached to the handle 19. The light 20 allows for easy location of the cage system. Other embodiments may place the light somewhere else or may omit the light entirely. The preferred embodiment has a water resistant flash light 21 attached to the handle 19. This allows someone carrying the cage system in the dark to be able to use one hand for both carrying the cage system and seeing where they are going, freeing up the other hand for something else. This could be important with hunters, who might need a free hand for a firearm.

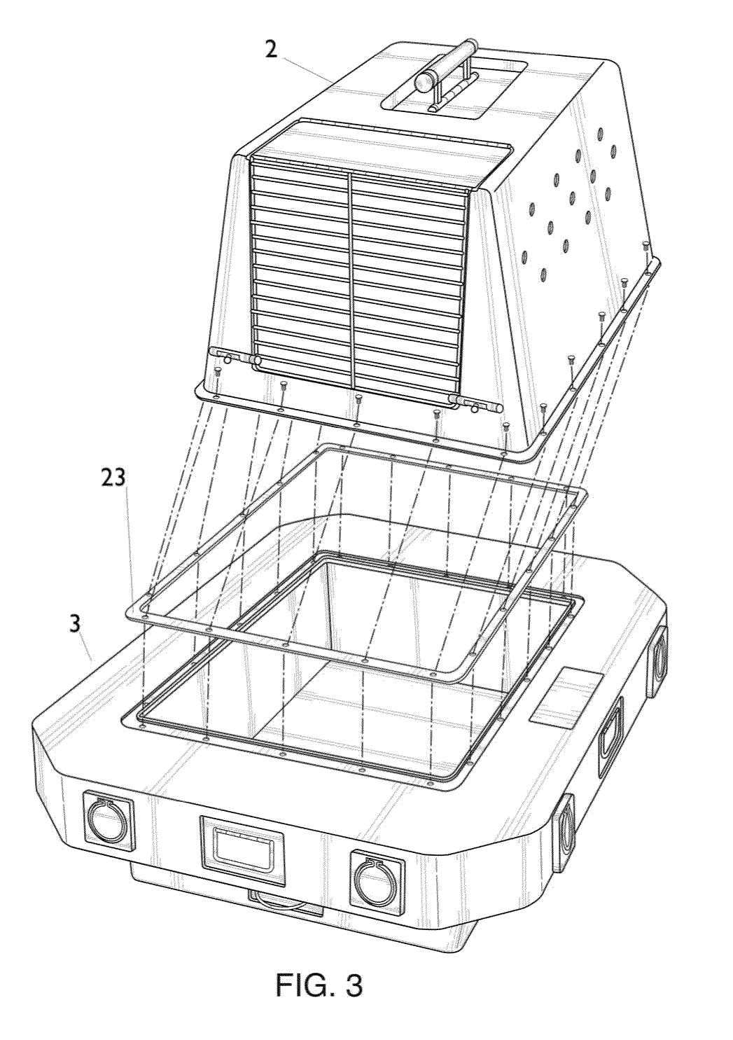

With reference to FIG. 3, in the preferred embodiment the top 2 sits in a recess 22 of the base 3. This allows for easy assembly by a consumer. The preferred embodiment of the invention has a gasket 23 that is placed between the top 2 and the base 3. The gasket 23 acts to ensure a relatively water resistant seal.

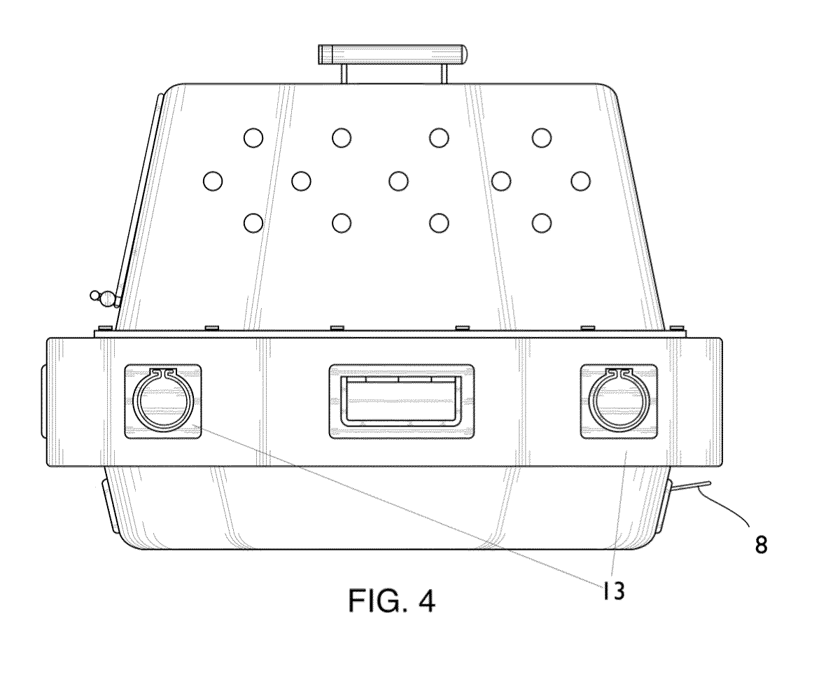

FIG. 4 shows a side view illustrating the tow hook 8 in extended position, and ring hooks 13 in retracted position.

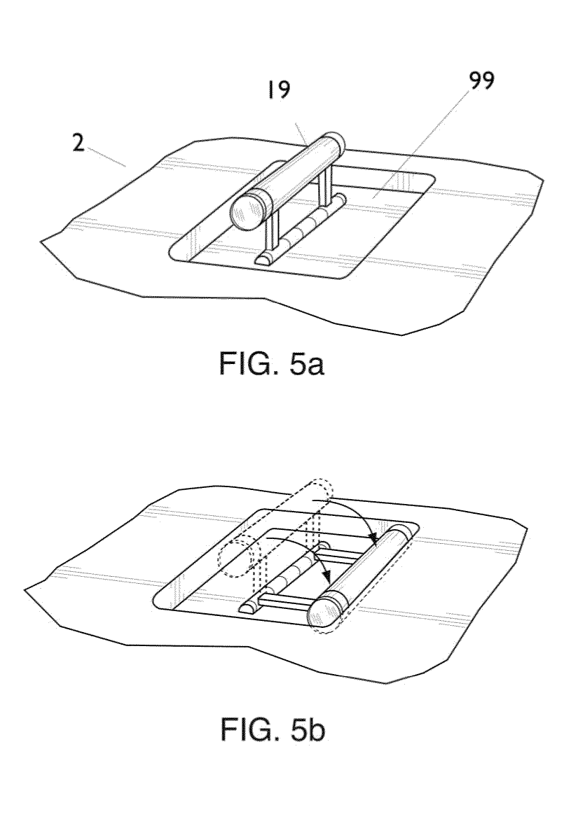

FIG. 5a shows handle 19 in the deployed position, ready for carrying. FIG. 5b shows handle 19 as it folds into recess 99 in top 2.

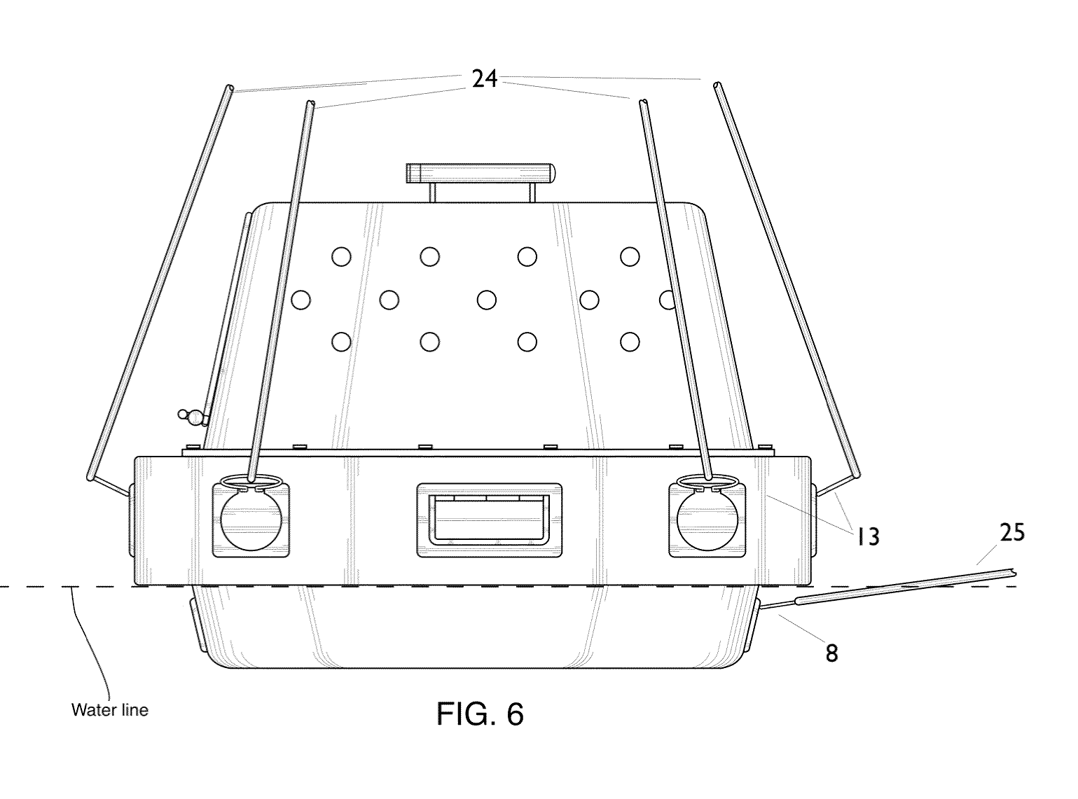

FIG. 6 shows the cage system in use, illustrating how the ring hooks 13 can be used to lift the cage system. Ropes 24 can be attached to each ring hook 13 allowing the entire cage system to be lifted without having the cage system become unbalanced. This is a particularly useful aspect in the case of air lifting the cage system. FIG. 5 also shows how the cage system can be towed along using the hook 8. A tow line 25 is attached or tied to the hook 8 and allows the entire cage system to be pulled. Note the low placement of the hook 8 allows for a more balanced towing.

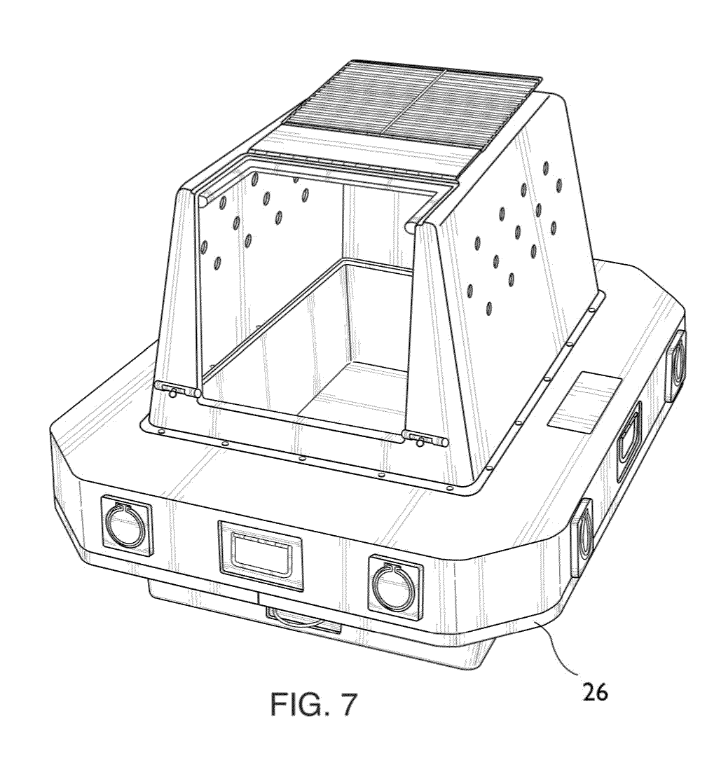

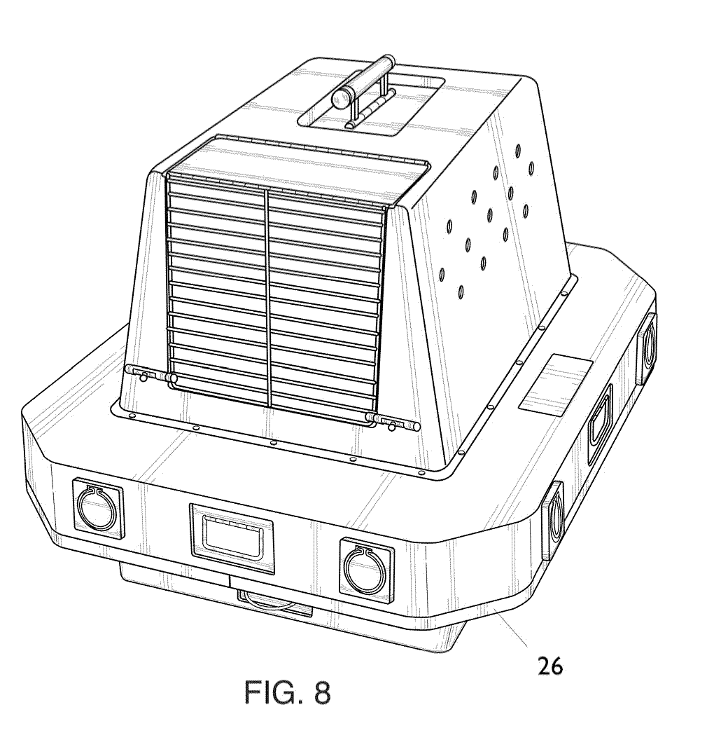

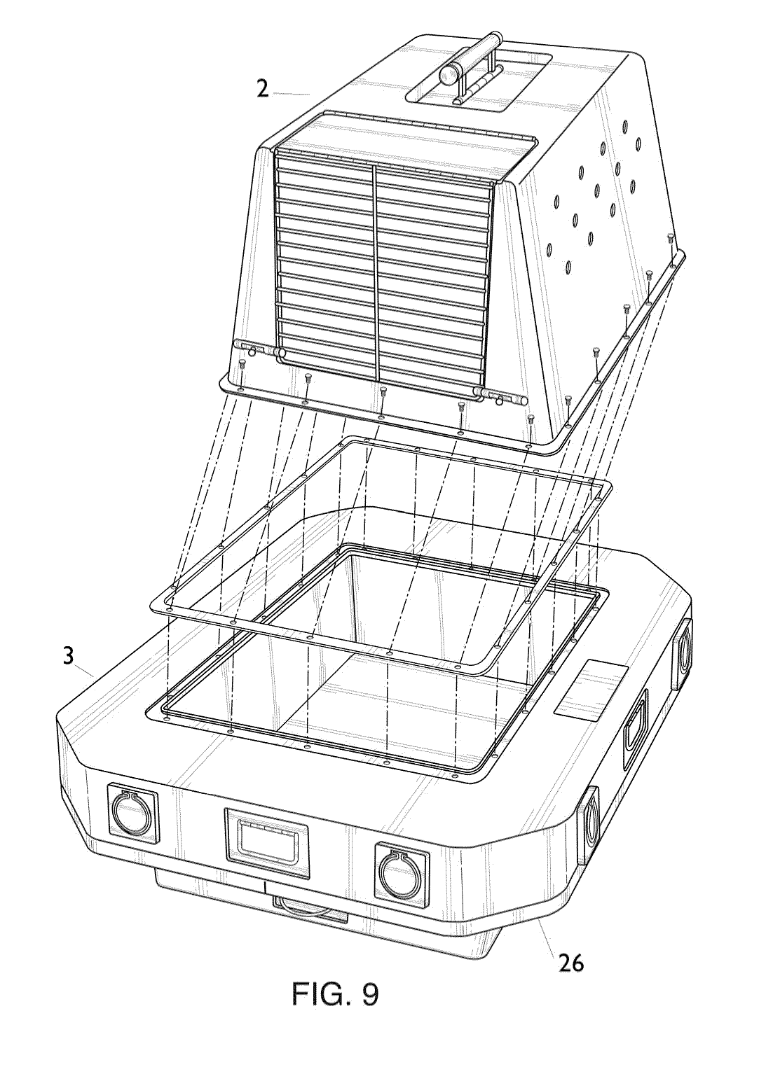

FIGS. 7 and 8 show another embodiment of the invention wherein outriggers 26 are attached to the base 3. In turbulent waters or to gain more stability, the outriggers 26 could be put into an open position. FIG. 7 shows the outriggers 26 in a closed position where the outriggers take up no more room than the base 3 itself, with the door open. FIG. 8 shows the outriggers closed and the door in a closed position. FIG. 9 shows an exploded perspective view of the mating of top 2 with base 3 that also has outriggers 26 in a closed position.

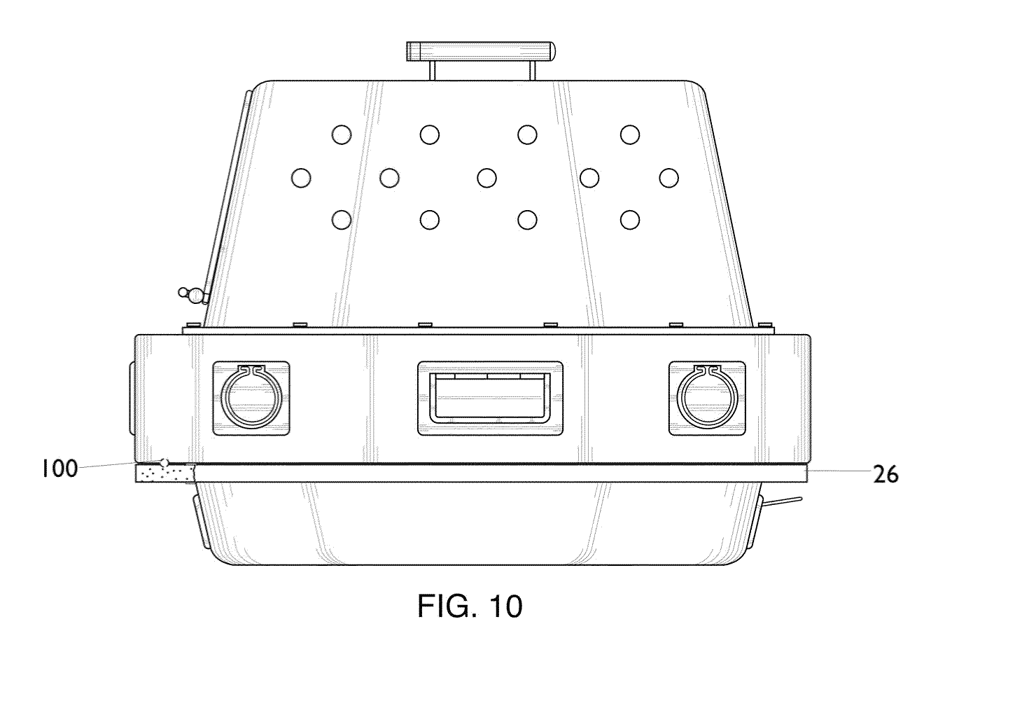

FIG. 10 shows a cutaway detail illustrating the operation of a ball-type catch 100 that serves to retain outrigger 26 in either a closed or an open position.

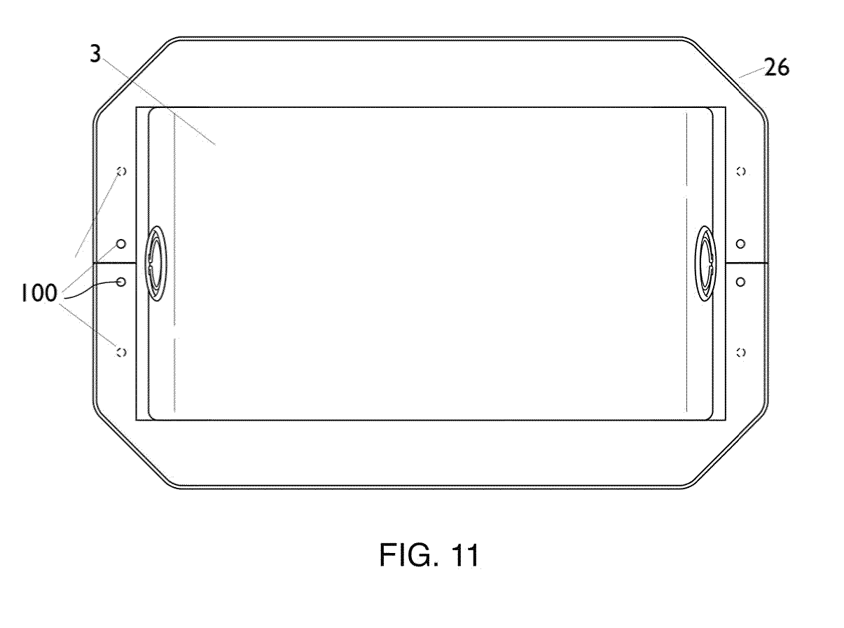

FIG. 11 shows a bottom plan view of the base 3 with outriggers 26 in closed position, further illustrating the function of ball catches 100.

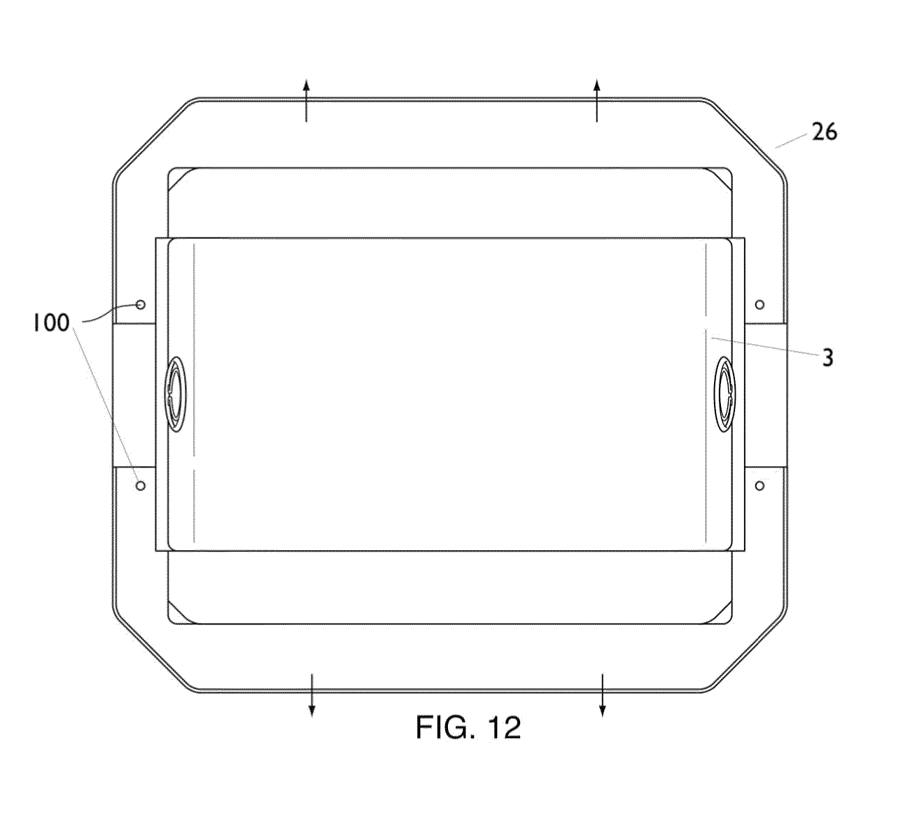

FIG. 12 shows a bottom plan view of the base 3 with outriggers 26 in the open position giving the cage system more stability and buoyancy. Outriggers would be particularly useful on larger cage systems, allowing for more efficient use of volume to counteract the added weight of the animal and size of the cage system. This embodiment envisions using a ball catch to secure the outriggers in either the open or closed position, however other ways to secure the outriggers are envisioned including but not limited to latches and clips.

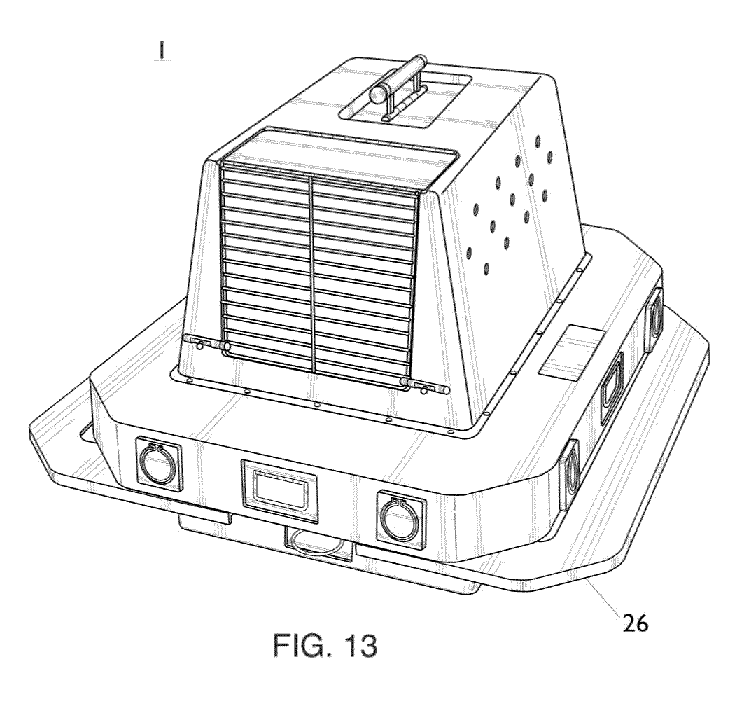

FIG. 13 is a perspective view of cage system 1 showing outriggers 26 in the extended position.

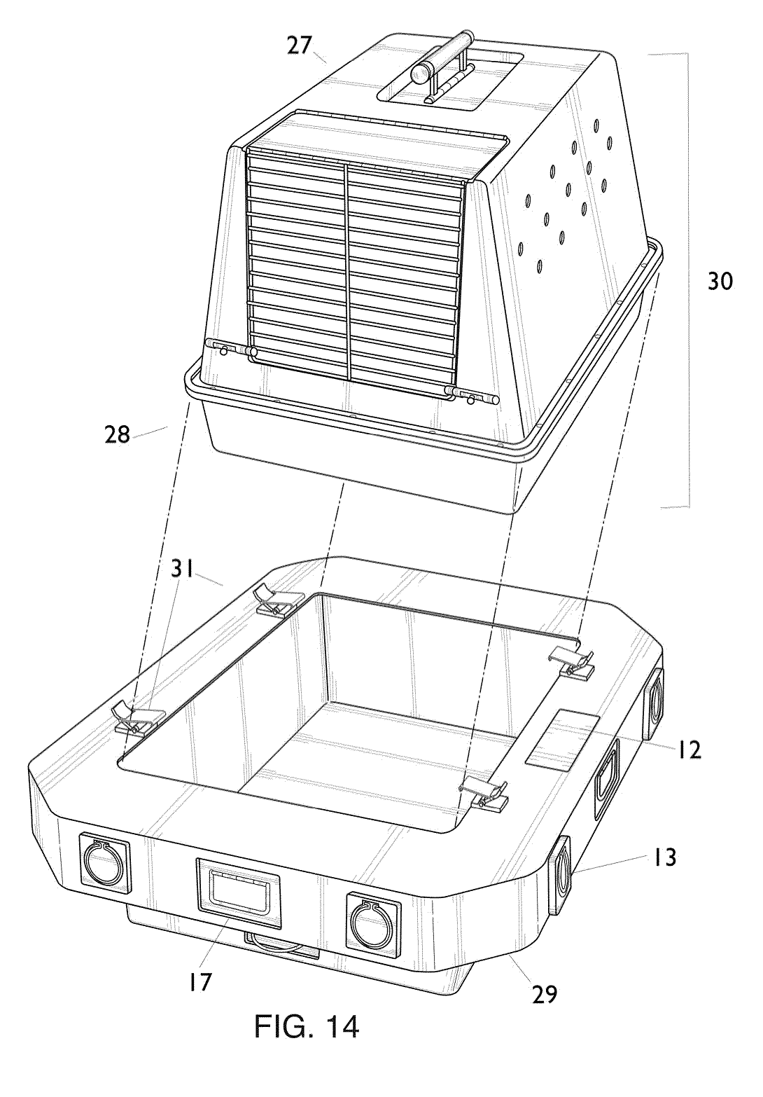

FIG. 14 shows another embodiment of the invention with a top 27, bottom 28, and a floating device 29. The top 27 and bottom 28 fasten together to form a single unit 30. A relatively water tight seal is formed between the top 27 and bottom 28 to prevent water from entering the interior. The unit 30 is then inserted and fastened to a floating device 29.

The floating device 29 is fastened to the unit 30 by quick connects 31. Other embodiments use other means to fasten the floating device to the unit 30, such as friction, ball catches, or slide latches.

In one embodiment, the floating device 29 is a singular tubular unit with no bottom that surrounds the bottom of the unit 30. The floating device 29 has the ring hooks 13, handles 7, and identification plate 12 attached to it.

In still a further embodiment, the floating cage of the present invention may be used on ice and snow, including partially melted ice and snow, such as by dragging across the surface or through the slush. In such instances, ribs or strakes (not shown) may be attached to, or incorporated into the underside of the unit to provide additional directional stability, particularly when pulled across surfaces that are inclined.

In a still further embodiment (not shown), the floating device 29 may be made in two or more segments that are assembled, but that are small enough, in their disassembled state, to fit within unit 30 and to be stored therein and carried in the disassembled state until needed for use.

In describing the above embodiments of the invention, specific terminology and simplification of data was selected for the sake of clarity and brevity. However, the invention is not intended to be limited to the specific terms so selected, and it is to be understood that each specific term includes all technical equivalents that operate in a similar manner to accomplish a similar purpose. While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may be made in the details within the scope and range of equivalents of the claims and without departing from the spirit of the invention.

The inventor further requires that the scope accorded the claims be in accordance with the broadest possible construction available under the law as it exists on the date of filing hereof (and of the application from which this application obtains priority, if any) and that no narrowing of the scope of the appended claims be allowed due to subsequent changes in the law, as such a narrowing would constitute an ex post facto adjudication, and a taking without due process or just compensation.

I claim as my invention:

1. A floating cage system for containing and transporting an animal over water comprising:
a buoyant base;
a top connected to the base, above the base, and defining therewith a space for containing an animal; and
a door attached to the top adapted to permit insertion and removal of the animal from the cage.

2. The floating cage system of claim 1 where the top and base have a seal to retard entry of water into the space.

3. The floating cage system of claim 1 wherein the door comprises a first hinge, a first door panel having at least two opposed edges, a second hinge, a second door panel, and one or more securing elements, wherein said first hinge is connected to the top and to a first edge of the first door panel, the second hinge is connected to a second edge of the first door panel opposed to the first edge of the first door panel and to the second door panel, and the securing element is adapted to secure the door in a closed position.

4. The floating cage system of claim 1 further where the door opens upwards.

5. The floating cage system of claim 1 further comprising hooks attached to the base.

6. The floating cage system of claim 1 further comprising one or more retractable buoyant outriggers attached to the base.

7. The floating cage system of claim 1 further comprising a handle on the top.

8. The floating cage system of claim 8 further comprising a beacon on the handle.

9. The floating cage system of claim 8 further comprising a flashlight attached to the top.

10. A floating cage system for containing and transporting an animal over water comprising:
a buoyant member;
a top, and a bottom, together defining a cavity to keep an animal contained;
a door attached to the top that can be in an open position or a closed position;
where the top and bottom attach together; and
where the attached top and bottom is secured to the buoyant member.

11. The floating cage system of claim 11 where the attached top and bottom is secured to the floating device by clips.

12. The floating cage system of claim 11 where the top and bottom have a seal to retard the entry of water to the cavity.

13. The floating cage system of claim 11 where the door comprises a first hinge, a first door panel having at least two opposed edges, a second hinge, a second door panel, and one or more securing elements, wherein said first hinge is connected to the top and to a first edge of the first door panel, the second hinge is connected to a second edge of the first door panel opposed to the first edge of the first door panel and to the second door panel, and the securing element is adapted to secure the door in a closed position.

14. The floating cage system of claim 11 further where the door opens upward.

15. The floating cage system of claim 11 further comprising hooks attached to the buoyant member for lifting the cage system.

16. The floating cage system of claim 11 further comprising a handle the top.

17. The floating cage system of claim 16 further comprising a beacon on the handle to allow for easy location of the cage system.

18. The floating cage system of claim 16 further comprising a flashlight.

19. The floating cage system of claim 10, further comprising strakes depending from the underside thereof to facilitate transport across snow or ice.

20. The floating cage system of claim 10, wherein the buoyant member is comprised of two or more sub-members, detachably joined, and wherein the sub-members may be retained within the cavity for storage or transport purposes.
